(19) United States
(12) Patent Application Publication
(10) Pub. No.: US 2023/0246553 A1
(43) Pub. Date: Aug. 3, 2023

(54) GaN-BASED SWITCHED-MODE POWER SUPPLY WITH PLANAR TRANSFORMER

(71) Applicant: INNOSCIENCE (SUZHOU) SEMICONDUCTOR CO., LTD., Suzhou City (CN)

(72) Inventors: Yanbo ZOU, Suzhou City (CN); Fada DU, Suzhou City (CN); Chao TANG, Suzhou City (CN); Wenjie LIN, Suzhou City (CN)

(21) Appl. No.: 17/969,707

(22) Filed: Oct. 20, 2022

Related U.S. Application Data
(63) Continuation of application No. 17/790,127, filed on Jan. 1, 0001.

(51) Int. Cl. H02M 3/335; H02M 7/217

(52) U.S. Cl. CPC H02M 3/33569; H02M 7/217

(57) ABSTRACT

A switched mode power supply is provided. The switched mode power supply includes an active clamped flyback converter with one or more GaN-based power semiconductor transistors and a planar transformer. The planar transformer includes a magnetic core and primary and secondary planar coil windings. The magnetic core includes a lower core and an upper core. The lower core has at least three projections including a central projection and two peripheral projections. The central projection is configured to accept the primary and the secondary planar coil windings which surround the central projection. The central projection has a stepped upper surface such that first and second gaps of different spacings are formed between the lower core and the upper core when the two peripheral projections contact the upper core.

### CROSS-REFERENCE TO RELATED APPLICATIONS

The present application is a continuation application of U.S. Non-Provisional patent application Ser. No. 17/790,127 filed Jun. 30, 2022, the disclosure of which is incorporated herein by reference in its entirety.

### FIELD OF THE INVENTION

The present invention generally relates to GaN-based switched mode power supplies. More specifically, the present invention relates to GaN-based switched mode power supplies with planar transformers exhibiting improved electrical and magnetic properties.

### BACKGROUND OF THE INVENTION

Switched mode power supplies are increasingly used in power converters from AC to DC and in electrical battery charging applications (mobile electronics, electric vehicles). Switched mode power supplies switch between full-on and full-off states with minimal time spent in transitions, which reduces energy wastage. Switching may take place at high frequencies up to several MHz; as a result, smaller transformers and other components (e.g., capacitors, inductors) may be used, permitting the overall footprint of power supplies and power converters to be reduced.

One technique for reducing the size of the transformer in switched mode power supplies is through the use of a planar transformer. In planar transformers, transformer coils are typically deposited on substrates using printed circuit techniques. However, conventional planar transformers may include magnetic flux lines that pass through the transformer coils, increasing loss and reducing system efficiency. For certain types of switched mode power supplies, the planar transformer may include a magnet gap that is less than optimal for variable current loads. Thus, there is a need in the art for improved GaN-based switched mode power supplies with improved planar transformers with improved magnetic and electrical characteristics.

### SUMMARY OF THE INVENTION

In accordance with one aspect of the present disclosure, a switched mode power supply is provided. The power supply includes a flyback converter with a GaN-based power semiconductor transistor and a planar transformer. The planar transformer includes a magnetic core and primary and secondary planar coil windings. The magnetic core has a lower core and an upper core. The lower core has at least three projections including a central projection and two peripheral projections. The central projection has a height extending above the heights of the two peripheral projections and accepts the primary and the secondary planar coil windings which surround the central projection. The upper core includes a recessed portion that receives the central projection of the lower core such that a gap is positioned between the central projection of the lower core and the recessed portion of the upper core when the two peripheral projections contact the upper core.

In another aspect, the present disclosure provides switched-mode power supply with an active clamped flyback converter. The active clamped flyback converter includes one or more GaN-based power semiconductor transistors and a planar transformer. The planar transformer includes a magnetic core and primary and secondary planar coil windings. The magnetic core includes a lower core and an upper core. The lower core has at least three projections including a central projection and two peripheral projections. The central projection is configured to accept the primary and the secondary planar coil windings which surround the central projection. The central projection has a stepped upper surface such that first and second gaps of different spacings are formed between the lower core and the upper core when the two peripheral projections contact the upper core.

### BRIEF DESCRIPTION OF THE DRAWINGS

FIG. 1 depicts a switched mode power supply with flyback converter according to an embodiment;

FIG. 2 is a cross-sectional side view of a planar transformer that may be used in the power supply of FIG. 1;

FIGS. 3A and 3B show the magnetic flux lines of a related art embodiment (FIG. 3A) and the transformer of FIG. 2 (FIG. 3B);

FIG. 4 is a perspective view of the planar transformer of FIG. 2;

FIG. 5 depicts a switched mode power supply with an active clamp flyback converter according to an embodiment;

FIG. 6 is a cross-sectional side view of the core of a planar transformer that may be used in the power supply of FIG. 5;

FIG. 7 is a cross-sectional side view of a planar transformer that may be used in the power supply of FIG. 5;

FIG. 8 is a plot of inductance vs. current for a planar transformer;

FIG. 9 is a plot of current vs. time for a planar transformer;

FIG. 10 is a plot of current vs. time for a planar transformer.

### DETAILED DESCRIPTION

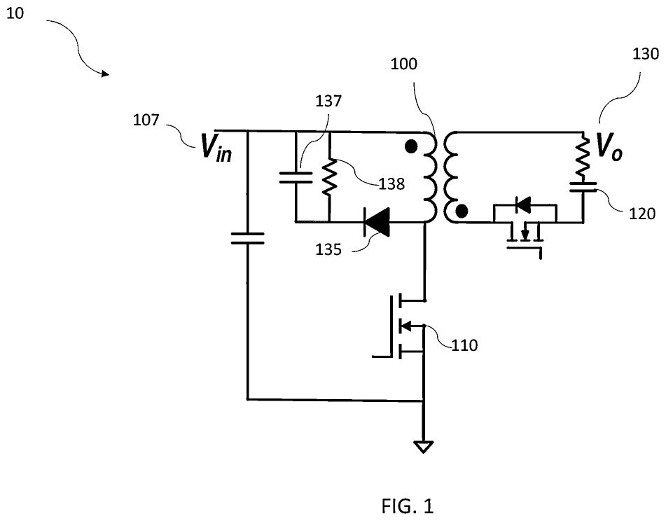

Turning to the drawings in detail, FIG. 1 is a switched mode power supply 10 according to an embodiment that includes a flyback converter configuration. Power supply 10 includes a GaN-based power semiconductor transistor 110 that is the main switch of the circuit. Transistor 110 is switched on and off at extremely high frequency, up to the megahertz range. When the GaN-based switching transistor 110 is in the “on” state, it conducts current; consequently, the voltage drop across transistor 110 is at its minimal value. In the “off” state, no current flows through transistor 110. This switching creates a high-frequency AC intermediary. The AC is rectified to produce the desired DC output when the switched mode power supply is used as an AC to DC converter. Alternatively, a DC input may be used and an output DC may be stepped up or stepped down.

The switched mode power supply of FIG. 1 has a flyback converter configuration. The flyback converter is a type of buck-boost converter that can produce an output voltage greater or less than the input voltage depending upon the duty cycle. The flyback converter configuration includes a clamp capacitor 137, resistor 138, and clamp diode 135.

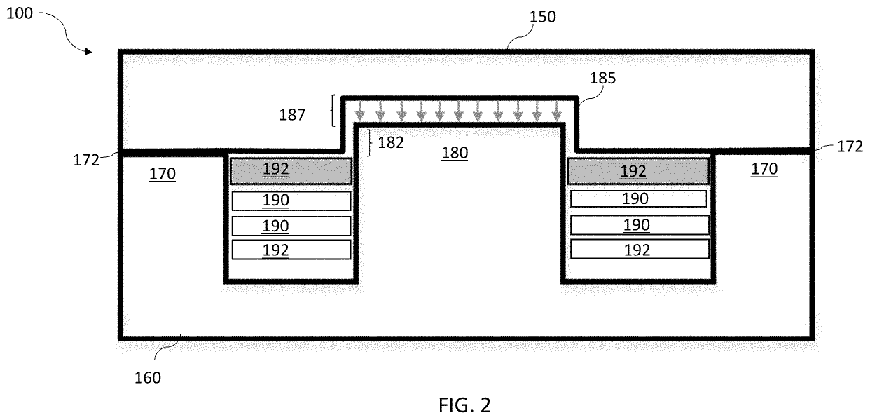

When the GaN-based switching transistor 110 is closed/off, a primary coil 190 (FIG. 2) of transformer 100 is directly connected to an input voltage source 107. The primary current and magnetic flux in the transformer increases. As a result, energy is stored in transformer 100. An induced voltage in the secondary coil 192 will be negative. Capacitor 120 supplies energy to the output load 130. When the GaN-based switching transistor is open/on, the primary current and magnetic flux drops. The secondary voltage is positive, and current flows from the transformer 100 and recharges capacitor 120.

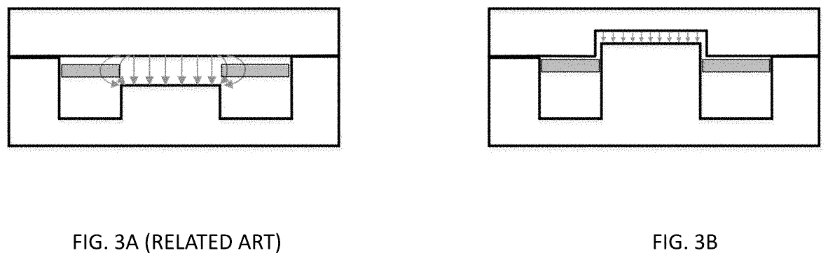

In order to increase the efficiency of the switched mode power supply 10, the transformer of FIG. 2 is provided. In the transformer of FIG. 2, the magnetic flux lines are shaped by the configuration of the magnetic core portions, as discussed in further detail below. The magnetic flux lines avoid the primary and second coils (as seen in FIG. 3B) in order to reduce the loss in the primary and second coils when the magnetic flux lines pass through the coil (as seen in FIG. 3A). Transformer 100 includes a magnetic core that includes a lower core 160 and an upper core 150. The lower core includes three projections: two peripheral projections 170 and a central projection 180. The central projection 180 has a height extending above the heights of the two peripheral projections (element 182 in FIG. 2 shows the height difference between peripheral projections 170 and central projection 180). The upper core 150 includes a recessed portion 185 that receives the central projection 180 of the lower core such that a gap 187 is positioned between the central projection 180 of the lower core and the recessed portion 185 of the upper core when the two peripheral projections contact the upper core at interface 172. The air gap 187 may have a thickness in a range from approximately 0.3 to approximately 1 mm.

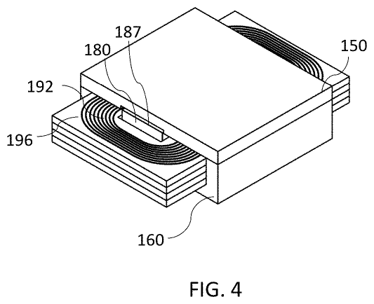

Surrounding the central projection 180 are primary planar coils 190 and secondary planar coils 192. The planar coils 190 and 192 may be metal lines (e.g., copper, nickel) deposited on a substrate such as a printed circuit board 196 (FIG. 4) or polymer substrate using printed circuit techniques. However, any technique may be used to create the planar metal coils 190 and 192. In the configuration shown in FIG. 2, the primary coils 190 are surrounded on the upper and lower sides by secondary coils 192; other arrangements may also be used. Alternative arrangements include alternating primary and secondary coils, or a set of one or more primary coils positioned adjacent to a set of one or more secondary coils. Each element 190 and 192 may be part of a set of side-by-side coils arranged in a planar spiral format, as seen more clearly in FIG. 4

FIG. 4 is a perspective view of the planar transformer of FIG. 2 with the primary coils 190 (not visible in FIG. 4) and secondary coils 192 disposed on substrates 196. Each of the coils is disposed in a spiral configuration surrounding the central projection 180 such that plural metal lines are in a coplanar configuration in each of the primary and secondary coil layers. Note that, depending on the selected number of windings, more or fewer layers of primary and secondary coils may be used in FIG. 4. Other optional layers (not shown) may provide shielding or insulation or other electrical components.

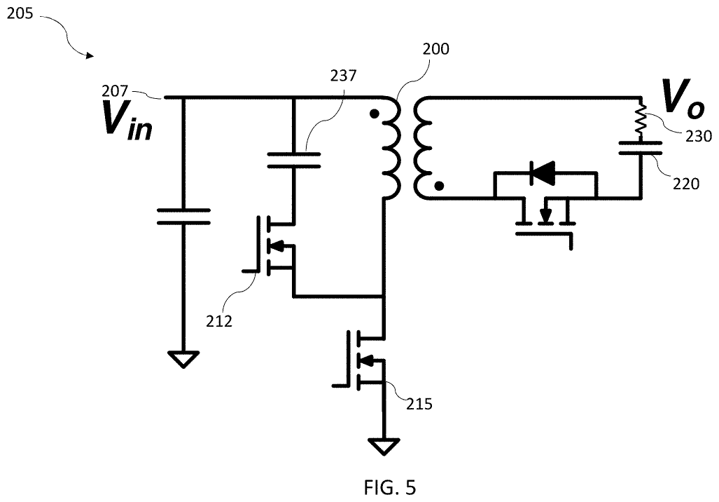

FIG. 5 is a switched mode power supply 205 including an active clamped flyback converter configuration. The power supply with active clamped flyback converter 205 differs from the power supply with a flyback converter 10 of FIG. 1 in that a switch 212 (that may be a GaN-based power semiconductor transistor) replaces the clamp diode 135. In the active clamped flyback converter 205, energy from the leakage inductance of transformer 200 is reused and supplied to load 230. This increases the efficiency of the switched mode power supply 210. Capacitor 220 alternately stores energy from transformer 200 and supplies energy to output load 230 as in the embodiment of FIG. 1, above.

In the power supply with active clamped flyback converter of FIG. 5, the peak voltage across the main switch 215 (GaN-based transistor) may be reduced; as a result, the on-resistance and conduction loss may be reduced. There is also a reduction in electromagnetic interference in the circuit of FIG. 5.

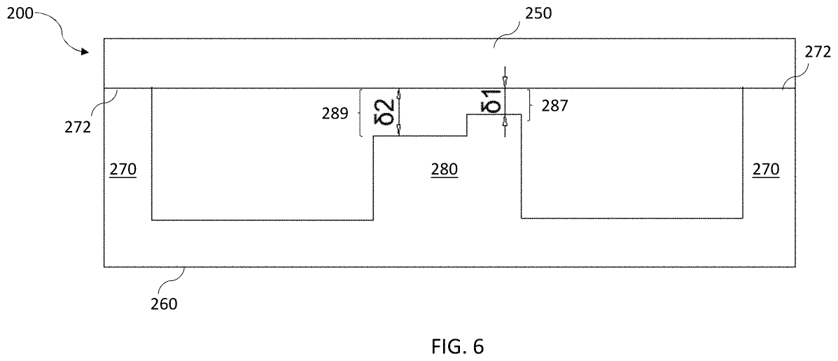

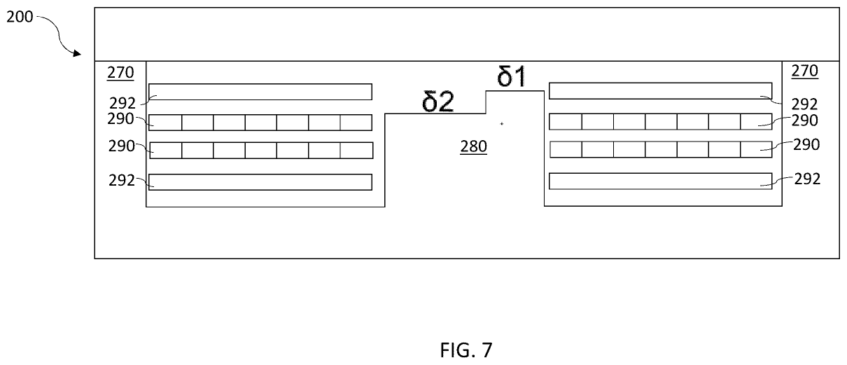

A novel transformer core configuration as shown in FIG. 6 is provided for the power supply with active clamped flyback converter of FIG. 5. In the transformer core configuration of FIG. 6, the magnetic core has a lower core 260 and an upper core 250. The lower core 260 has at least three projections including a central projection 280 and two peripheral projections 270. The central projection 280 accepts the primary 290 and the secondary 292 planar coil windings which surround the central projection, as seen in the transformer of FIG. 7. The central projection has a stepped upper surface such that a first air gap δ₁ 287 and a second air gap δ₂ 289 with different spacings exist between the lower core and the upper core when the two peripheral projections 270 contact the upper core at interface 272. The first air gap δ₁ 287 may have a spacing in a range of approximately 0.1 to 0.4 mm and a second air gap δ₂ 289 may have a spacing in a range of approximately 0.5 to 1.0 mm.

The stepped air gap including gaps δ₁ and δ₂ is provided to reduce the light-load frequency. The δ₁ air gap is increased as compared to a conventional single air gap. The air gap δ₁ is less than the air gap δ₂. When the current flow is light, the low current inductance is designed to be a larger value. When there is a large current flow, the smaller air gap δ₁ is saturated to reduce the inductance due to the increase of the current. As a result, the light load efficiency is improved.

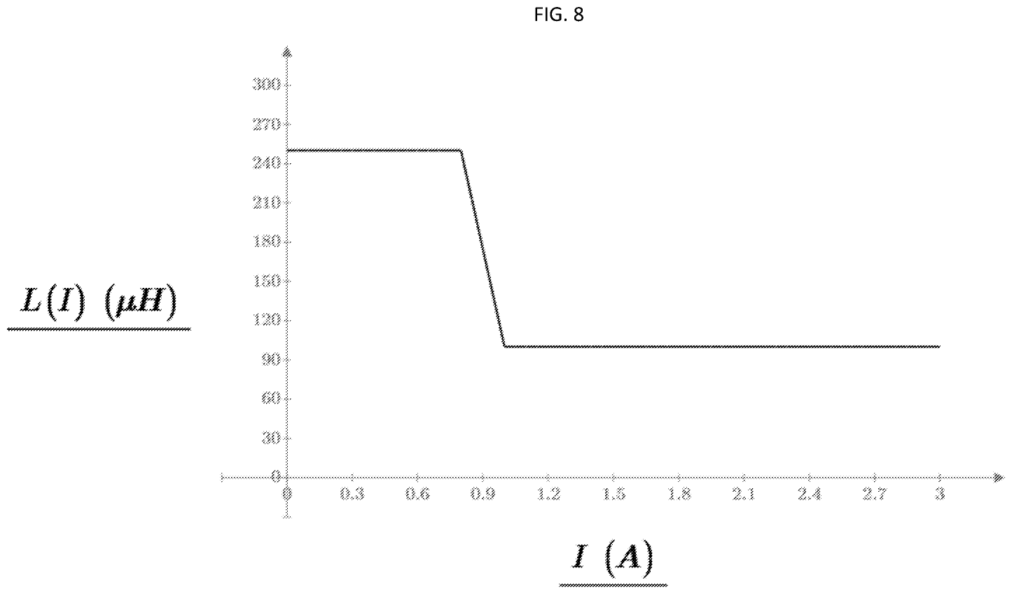

Turning to the planar transformer of FIG. 7, the central projection 280 is surrounded by primary planar coils 290 and secondary planar coils 292. The planar coils 290 and 292 may be metal lines deposited on a substrate such as a printed circuit board or polymer substrate using printed circuit techniques, as shown in the embodiment of FIG. 4, above. However, any technique may be used to create the planar metal coils 290 and 292. In the configuration shown in FIG. 8, the primary coils 290 are surrounded on the upper and lower sides by secondary coils 292; other arrangements may also be used. Each element 290 and 292 may be part of a set of side-by-side coils arranged in a planar spiral format.

Using the transformer of FIG. 7, the light load efficiency of the power supply 205's continuous working mode (CRM) is greatly improved, so that the active clamped flyback configuration's continuous working mode can pass the energy efficiency standard of an adapter using power supply 205. Further, the transformer volume does not need to be increased while reducing the active clamped flyback configuration power supply's light load frequency. Additionally, the heavy load frequency of the power supply is improved for high voltage input, reducing transformer loss by approximately 10%.

### Example 1

When the transformer 200 is operating, the inductance will be determined by δ2 when the current increases to the saturation value of the air gap δ1. For example, as shown in FIG. 8, the abscissa represents the current flowing through the primary coil of the transformer, and the ordinate represents the inductance of the transformer. Set as 0.8 A δ1 saturation, the inductance before δ1 saturation is 250 uH, and the inductance after saturation is 100 uH.

### Example 2

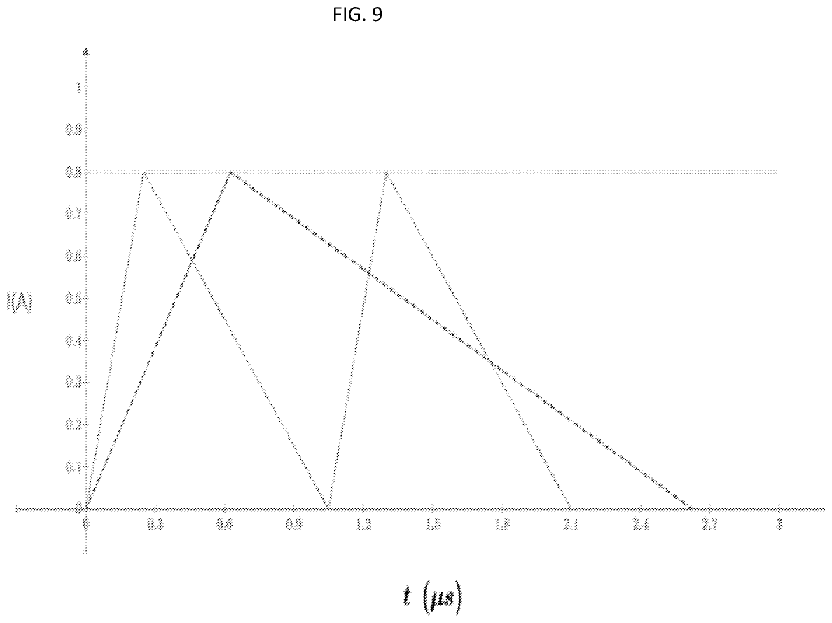

FIG. 9 shows the comparison between a conventional single air gap transformer and the light load current waveform of the stepped air gap transformer 200. At light loads, the 250 uH frequency is 60% lower than the single breadth 100 uH frequency due to the larger inductance.

### Example 3

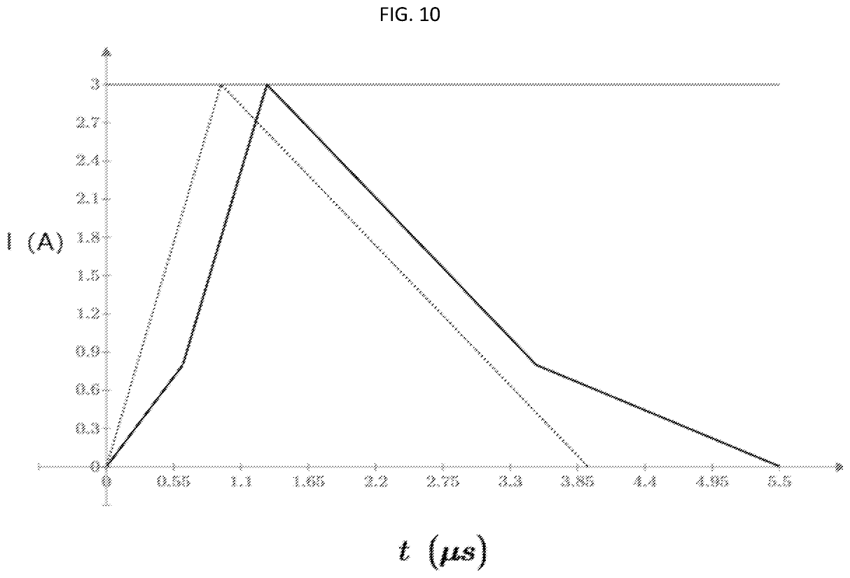

FIG. 10 shows the comparison between a conventional single air gap transformer and the light-load current waveform of the stepped air gap transformer 200. The transformer current increases under heavy load and the inductance decreases to 100 uH after M is saturated. The frequency does not change much for a single air gap transformer.

### INDUSTRIAL APPLICABILITY

The switched mode power supplies of the present invention may be used in AC-DC converters, DC-DC converters, electronic device (e.g., mobile phone) battery chargers, and electronic vehicle battery chargers.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 within 5 within 1 or within 0.5 μm located along the same plane. When reference is made to “substantially” the same numerical value or characteristic, the term may refer to a value within ±10%, ±5%, ±1%, or ±0.5% of the average of the values.

1. A switched-mode power supply comprising:
an active clamped flyback converter (210) including:
one or more GaN-based power semiconductor transistors (210 or 215);
a planar transformer including a magnetic core and primary and secondary planar coil windings, the magnetic core including a lower core (260) and an upper core (250), the lower core (260) having at least three projections including a central projection (280) and two peripheral projections (270), the central projection (280) being configured to accept the primary (290) and the secondary (292) planar coil windings which surround the central projection, the central projection including a stepped upper surface such that first (287) and second (289) gaps of different spacings exist between the lower core and the upper core when the two peripheral projections contact the upper core (272).

2. The switched-mode power supply of claim 1, wherein the primary and secondary planar coil windings are disposed on one or more planar substrates.

3. The switched-mode power supply of claim 2, wherein the one or more planar substrates include one or more printed circuit boards.

4. The switched-mode power supply of claim 1, wherein the primary planar coil windings are surrounded in upper and lower planes by secondary coil windings.

5. The switched-mode power supply of claim 1, wherein the magnetic core is a ferrite core.

6. The switched-mode power supply of claim 1, wherein the active clamped flyback converter further includes an output capacitor (220) for storing power from the transformer in an off-state.

7. The switched-mode power supply of claim 1, wherein the first gap has a spacing in a range of approximately 0.1 to 0.4 mm and the second gap has a spacing in a range of approximately 0.5 to 1.0 mm.

8. An electronic device charger including the switched-mode power supply of claim 1.

9. An AC-to-DC converter including the switched-mode power supply of claim 1.
